(19) United States
(12) Patent Application Publication
(10) Pub. No.: US 2009/0103322 A1
(43) Pub. Date: Apr. 23, 2009

(54) Tri-bar headlight assembly with interchangeable colored dots

(76) Inventor: Lawrence Andrew Hoffman, Portland, OR (US)

Correspondence Address: MARK S. HUBERT P.C., 516 SE MORRISON- SUITE 1200, PORTLAND, OR, 97214, US

(21) Appl. No.: 11/975,869

(22) Filed: Oct. 22, 2007

(51) Int. Cl. F21V 7/00; F21V 5/00

(52) U.S. Cl. 362/516

(57) ABSTRACT

A motor-vehicle headlight assembly which has an interchangeable colored translucent cup centered over the light source by a three linear member housing. The headlight assembly also has a region of its lens colored differently with a reflective enclosure behind it wherein a signal light resides. This allows the installer to change both the look of the headlight and the color of the center most region of the light beam emitted from the headlight.

### BACKGROUND OF THE INVENTION

The present invention relates to a vehicle headlight assembly, and more particularly, to an automobile headlight assembly that incorporates the turn signal indicating light and an interchangeable colored headlight marker.

With many automobile owners not satisfied with the style, quality, and availability of the features provided by the automakers, owners have turned to aftermarket component manufacturers and even automobile kit manufacturers for satisfaction. The owners of hot rod, street rod, and classic automobiles are always looking for ways to customize and differentiate their cars from others, and styling, shape and form are high on the list of attributes that these owners wish to improve. The automobile customizing industry continuously strives to provide new and exciting features for such consumers.

Automobile headlights have not escaped the strong demand for a custom look. Often car owners are looking to combine design elements from the past, with the smooth look, and increased aerodynamic efficiency of the latest technology. This tri-bar headlight assembly with interchangeable colored dots incorporates an interchangeable translucent dot (marker) centered in front of the light path of a vehicle headlight. When the headlight is illuminated, it will appear to have a small colored in the middle of its beam. This allows viewers to distinguish ownership of same model vehicles before they pass on the road. Thereby giving them advance notice of their passing friends. In another embodiment it also has the signal indicator light incorporated into the same headlamp enclosure. Thus car customizers can remove the existing signal lights of a vehicle and eliminate their body orifices to give the vehicle a smooth, custom look. Today there is a desire that headlights fulfill an origin indicating function, as well as improve the aerodynamics of the front of the vehicle.

### SUMMARY OF THE INVENTION

The general purpose of the present invention, which will be described subsequently in greater detail, is to provide a means for replacing interchangeable multi-colored dots in the center of a tri-bar style headlight.

It is another object of this invention to provide improved vehicle aerodynamics by allowing the turn signal lights to be eliminated providing a smoother look.

The present invention has the advantages mentioned heretofore and many novel features that result in a new headlight assembly which is not anticipated, rendered obvious, suggested, or even implied by any of the prior art, either alone or in any combination thereof.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a front view of the headlight assembly;

FIG. 2 is a back view of the headlight assembly;

FIG. 3 is a top view of the headlight assembly;

FIG. 4 is a right side view of the headlight assembly;

FIG. 5 is a bottom view of the headlight assembly;

FIG. 6 is a top view of the tri-bar assembly;

FIG. 7 is a cross-sectional view of the dot retention ring, dot and spring assembled;

FIG. 8 is a bottom view of the tri-bar assembly;

FIG. 9 is a top view of the dot; and

FIG. 10 is a side view of the dot retention ring.

### DETAILED DESCRIPTION

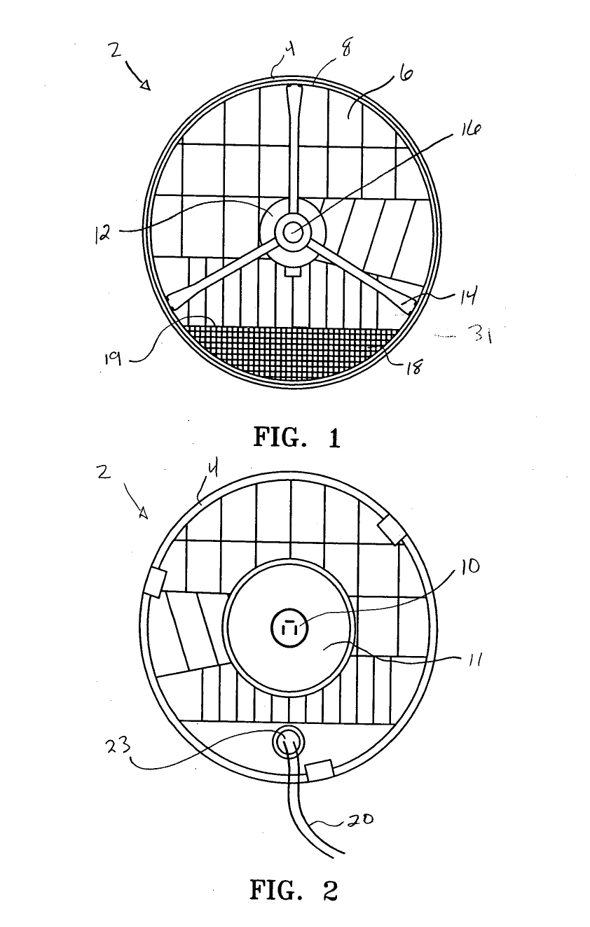

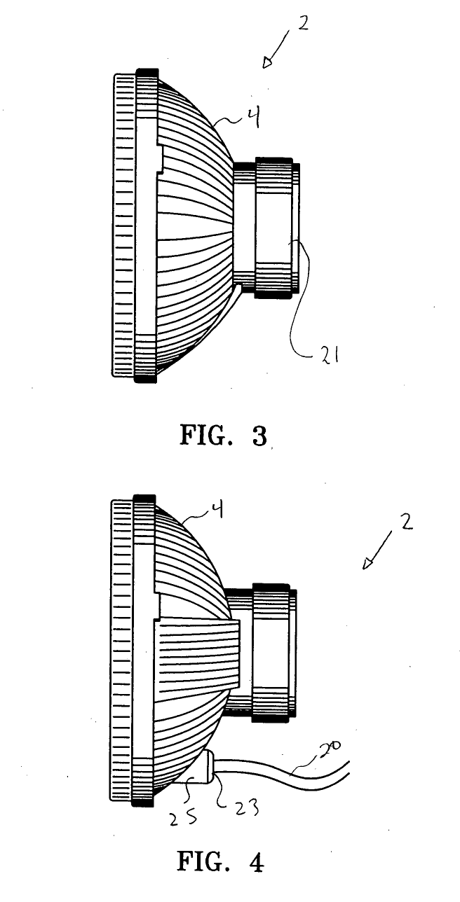

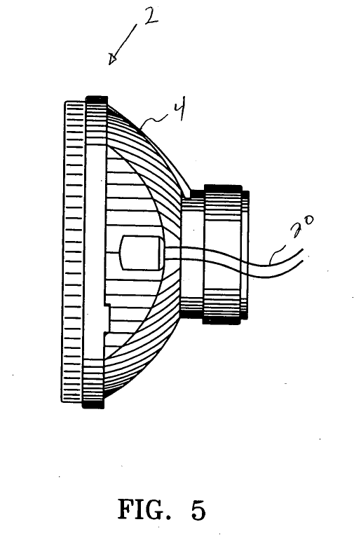

Referring in particular to FIG. 1 through 5, the headlight assembly 2 of the present invention is generally shown. The headlight assembly 2 resides in a housing 4 that is connected to the motor vehicle (not shown). The headlight assembly 2 includes a reflector member 6, a lens 8, a light source (not visible), a tri-bar assembly 12 of dot retention ring 13, bars 14 and a translucent colored dot or cup 16, and a turn signal indicator light 18.

The reflector member 6, is preferably made from or coated in a metallic compound, or any other suitable reflective material and is generally round sized in the conventional vehicle headlight recess diameters, and in cross section is parabolic in shape. The lens 8 is preferably made from laminated or tempered safety glass or a suitable transparent polymer, and is attached to the housing 4 via an adhesive. The replaceable light source 10 can be any conventional lightbulb. For protection a rubber gasket 11 encapsulates and seals any space between the light source 10 and the light source support 21 which extends normally from the back of the housing 4. The preferred embodiment also includes a turn signal indicator segment 18 as shown in FIG. 1. Here a segment of the lens 8 is colored. At the interface 19 between the colored and clear section of the lens 31 extends an opaque divider (not illustrated) extending normally from the back of the lens 8 and residing between the lens 8 and the reflector member 6. Behind this turn signal indicator segment 18 is a signal light assembly 23 which is frictionally engaged in the signal light support 25 which extends normally from the back of the housing 4. Wires 20 connect the signal light assembly 23 to the vehicle's power. Reference FIGS. 2, 4 and 5.

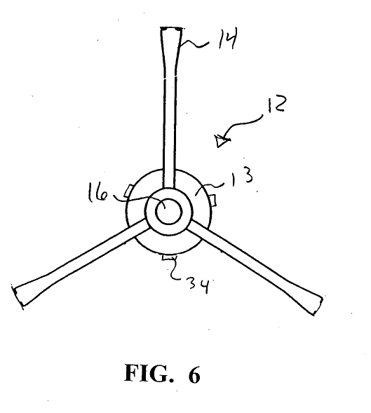

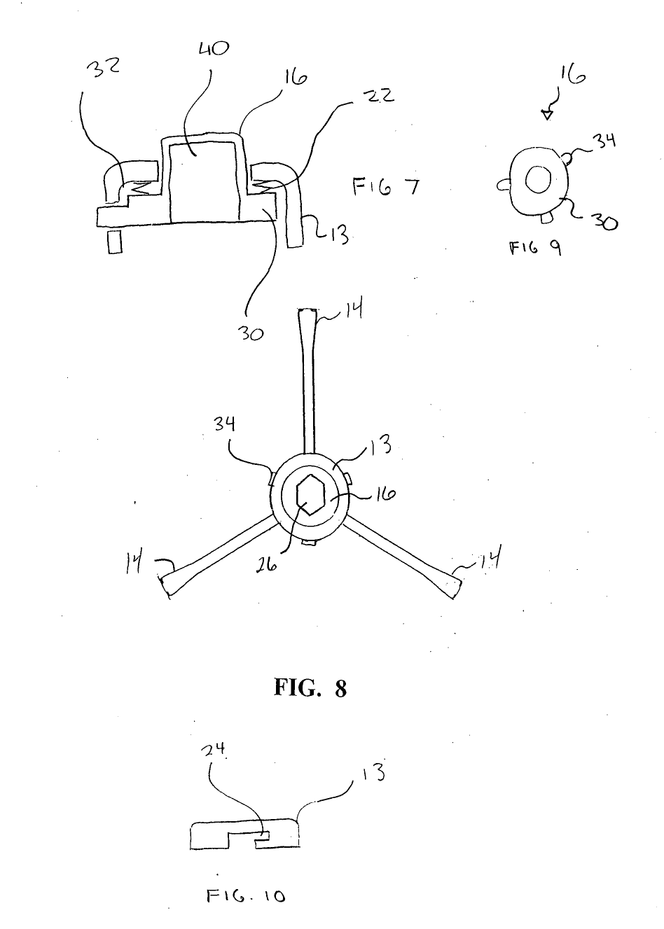

The tri-bar assembly 12 is illustrated in FIGS. 6 through 10. The assembly 12, houses a colored dot 16, which can be interchangeably exchanged with a different colored dot, to change the appearance of the vehicle's headlight. The dot 16 is fabricated from a translucent, heat resistant polymer, or any other suitable material. The dot 16 is housed directly over the light source 10. The dot 16, is constrained within the dot retention ring 13 of tri-bar assembly 12 via a spring 22 frictionally engaged between the dot flange 30 and the dot concave inner surface 32. The dot flange 30 has three equidistant locking protrusions 34 formed thereon its outer periphery. These protrusions 34 rotatably lock into the three equidistant detents 24 which are formed into the side wall of the dot retention ring 13 as illustrated in FIG. 7. The dot 16 can be rotationally engaged/disengaged utilizing the hexagonal recess 26 formed into the central void 40 of the dot retention ring 13. The recess 26 is adapted for engagement with a conventional hexagonal key or wrench. The tri-bar housing 12 is mechanically connected to the headlight housing 4 via three bars 14.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed.

Having thus described the invention, what is claimed as new and desired to be secured by Letters Patent is as follows:

1. A headlight assembly comprising:
a parabolic housing with a reflective surface formed thereon;
a lens enclosing said housing;
at least one light emitting source contained therein said enclosed housing;
a tri bar assembly of a cup retention ring with three equidistantly spaced linear members extending therefrom;
at least one colored translucent cup;
wherein said linear members are connected onto said parabolic body and adapted to position said cup retention ring adjacent said light emitting source, and said translucent cup is frictionally engaged therein said cup retention ring.

2. The headlight assembly of claim 1, wherein said translucent cup has a peripheral flange with at least one engagement tab formed thereon, and wherein said cup retention ring has at least one slot formed therein that is matingly conformed to said engagement tabs such that said cup may be interchangeable by twistable engagement with said cup retention ring.

3. The headlight assembly of claim 2, further comprising a spring means adapted for placement between said cup and said cup retention ring to enhance said frictional engagement.

4. The headlight assembly of claim 3, wherein said cup contains a recessed hexagonal orifice formed therein.

5. The headlight assembly of claim 4 wherein said number of tabs and engagement slots is three.

6. The headlight assembly of claim 4 further comprising a signal light emitting source interchangeably retained within a second chamber extending normally from said housing back.

7. The headlight assembly of claim 6 wherein said housing has a front concave reflective surface and a back convex surface, and wherein a main light emitting source is interchangeably retained within a first chamber extending normally from said housing back.

8. The headlight assembly of claim 7 wherein said lens has a first clear section and a second colored section.

9. The headlight of claim 8 wherein said first clear section of said lens is adjacent said main light emitting source and said colored section of said lens is adjacent said signal light emitting source.
